(19) United States
(12) Patent Application Publication
(10) Pub. No.: US 2018/0124606 A1
(43) Pub. Date: May 3, 2018

(54) SYSTEM AND METHOD FOR EMERGENCY RESPONSE PORTAL VIDEO CAMERA FEED INTEGRITY

(71) Applicant: 9069569 Canada Inc., Ottawa (CA)

(72) Inventors: Mark Irwin Macy, Ottawa (CA); Ross Maclachlan, Ottawa (CA)

(21) Appl. No.: 15/797,203

(22) Filed: Oct. 30, 2017

Related U.S. Application Data
(60) Provisional application No. 62/414,194, filed on Oct. 28, 2016.

(51) Int. Cl. H04W 12/06; H04W 12/08; H04W 12/10; H04L 29/06; H04W 76/00

(52) U.S. Cl. CPC H04W 12/06; H04W 12/08; H04W 12/02; H04L 63/205; H04W 76/007; H04W 12/10

(57) ABSTRACT

A system and method to ensure video integrity for providing on-site images for emergency services is disclosed. An emergency response portal server can establish virtual private networking (VPN) connections to a router associated with a location, building or campus to enable police, fire, emergency medical services access to on-scene images. The system provide notifications to contacts associated with the location and ensure that access to the information is logged and tracked ensure privacy and security.

### CROSS-REFERENCE TO RELATED APPLICATIONS

This application claims priority to U.S. Provisional Patent Application No. 62/414,194 filed Oct. 28, 2016 the entirety of which is hereby incorporated by reference for all purposes.

### TECHNICAL FIELD

The present disclosure relates to providing video camera feeds and in particular to remotely accessing video feeds securely.

### BACKGROUND

When an emergency incident occurs, access to on-scene video images or feeds by emergency services, such as police, fire and emergency medical services can provide valuable situational awareness information. However gaining access to the video cameras and ensuring the integrity of images and access to the cameras presents security and privacy issues. In addition, the ability for emergency services to quickly access location information can be critical in resolving the situations successfully. Providing secured connections to multiple locations and the associated cameras presents security and networking challenges as virtual private network connections are routers are traditionally configured for one to many access. Accordingly, systems and methods that enable access to video feeds in emergency situations remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a system for video feed integrity;

FIG. 2 shows a representation of message flow for video feed integrity;

FIG. 3 shows a method of commissioning video integrity; and

FIG. 4 shows a method of operation of video feed integrity.

It will be noted that throughout the appended drawings, like features are identified by like reference numerals.

### DETAILED DESCRIPTION

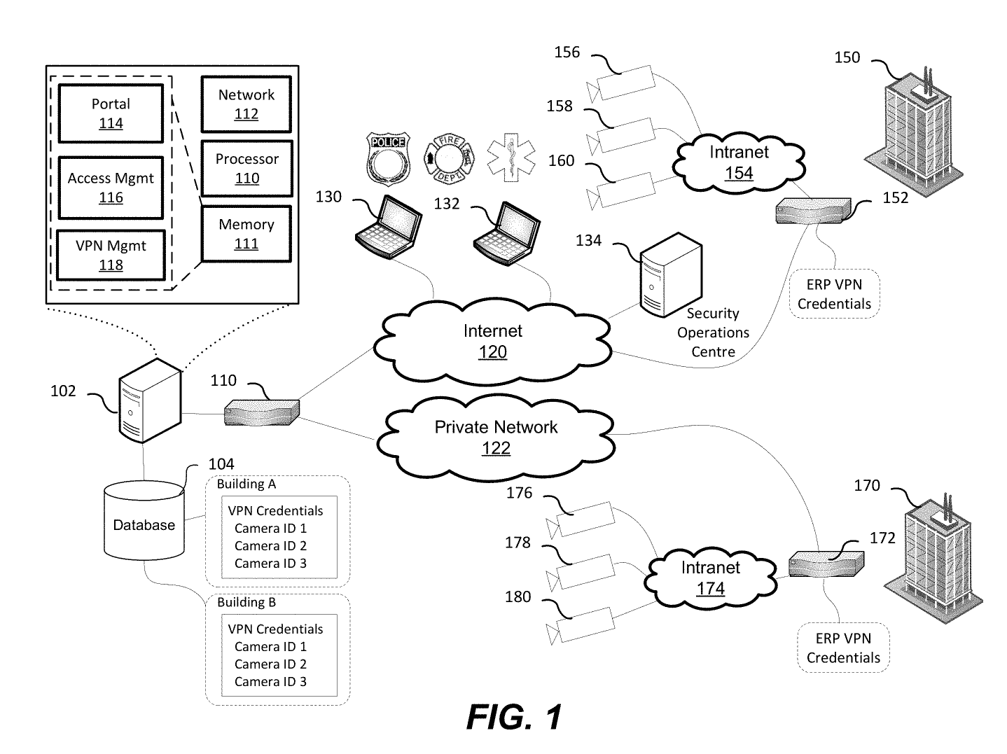

Embodiments are described below, by way of example only, with reference to FIGS. 1-4.

In accordance with an aspect of the present disclosure there is provided a system for video integrity through an emergency response portal (ERP), the system comprising: a router at a property locations coupled to an intranet the router having a virtual private network (VPN) certificate associated the emergency response portal; and an ERP server coupled to a network for receiving an access request from a device associated with an emergency response service to information associated with a property location, the server configures the VPN with the router at the property location and accesses images from one or more cameras at the location to be provided to an emergency responder service through the ERP server; wherein the server stores IP addresses associated with the one or more cameras and credentials to access the one or more cameras, and subsequent requests to access information for the property location is retrieved from the server, wherein images from the cameras are stored on the server rather than accessing the property location again.

In accordance with another aspect of the present disclosure there is provided method of video integrity at an emergency response portal, the method comprising: a receiving a request from an emergency response service to access video associated with a property location at a server; verifying credentials associated with the request at the server and generating a notification of an access request to a property owner associated with the location; establishing a virtual private network (VPN) between the server and a router at the property location; accessing one or more cameras at the location connected to an intranet at the location; retrieving an image from the one or more cameras; and providing the image to a device associated with the request from the emergency response service.

In accordance with yet another aspect of the present disclosure there is provided a non-transitory computer readable memory containing instructions for video integrity at an emergency response portal, the instructions which when executed by a processor perform the method of: a receiving a request from an emergency response service to access video associated with a property location at a server; verifying credentials associated with the request at the server and generating a notification of an access request to a property owner associated with the location; establishing a virtual private network (VPN) between the server and a router at the property location; accessing one or more cameras at the location connected to an intranet at the location; retrieving an image from the one or more cameras; and providing the image to a device associated with the request from the emergency response service.

In accordance with an embodiment the router and server have corresponding VPN certificates.

In accordance with an embodiment the server and router are connected via a private network.

In accordance with an embodiment the one or more cameras are coupled to a network video server (NVS).

In accordance with an embodiment a notification is sent to a contact associated with the property when the request is received to access one or more cameras at the location by the emergency responder service.

In accordance with an embodiment credentials of the device or user of the emergency responder service are verified by the ERP server.

In accordance with an embodiment the request to access the information is provided to a security operations centre external to the property location for confirmation before allowing access.

In accordance with an embodiment the VPN is terminated between the portal and the router when the requesting device is not connected.

In accordance with an embodiment the router is configured to only establish a VPN connection with a known static IP address of the server.

FIG. 1 shows a representation of a system for ensuring video feed integrity. An emergency response portal (ERP) server 102 provides emergency services access to on-location or scene information and access to on-site video camera feeds. The emergency services enables police, fire, paramedics, etc. to access information related to a location through a 3^{rd} party interface which provides information related to a commercial property. The ERP server 102 contains information such as tenants of the building, floor plan layouts, hazardous material locations, contact information and access to video feeds. The owner of the property grants access to the information to the emergency services and is notified when access to the information occurs. The ERP server 102 hosts multiple properties enabling the emergency service to have one location to access to obtain the information required when responding to a call to a particular property.

The server 102 may comprise one or more computing devices having at least a processor 110, memory 111 and network interface 112 coupled to one or more networks. The server 102 may be hosted at a single location or provided by a cloud or network computing service. The memory 111 contains instructions which when executed by the processor 110 provide functionality to implement the emergency response portal which can be access through the Internet 120 or a private network 122. The private network 122 may be a wired or wireless network. For example the private network 122 may be confirmed by for example an Multiprotocol Label Switching (MPLS) wired network or an access point name (APN) mobile network configured on a public network. The portal 114 provides a web or application specific interface to access site or property information associated with particular locations such as a building 150 or building 170. Access management module 116 controls access to property information by mobile or computing device 130 or computing device 132 associated with emergency services such as fire, police, or EMS. When access to information associated with a building is requested, the access request is authorized and notifications of the access is provided to a building owner or security operations center 134. The database 104 of the ERP portal coupled to the server 102 contains information associated with the building such as floor plan, access codes, contact information, hazardous material information, and cameras that are available. In order to endure the security of the video feed a virtual private network (VPN) module 118 manages VPN credentials associated with a router configured at each location, building or campus. A router 152 for building 150 or router 172 for building 170 maintains VPN credentials associated with server 102 to allow the server to access on site cameras. For example the intranet 154 of building 150 has cameras 156-160 and intranet 174 of building 170 has cameras 176-180 connected thereto. When a request to access information associated with a building 150 is received from a computing device 130 through the Internet 120, the credentials of the user 130 is verified and a notification of access is provided to a contact associated with the building or property 150. An authorization message may be sent to a security operations center 134 associated with the building or location, or the emergency service control center to require approval before access to information of video feeds is provided to the user 130. The server 102 determines the VPN credentials associated with the router 152 and initiates a VPN session using the credentials. The server 102 may initiate the VPN itself or provide VPN credentials to configure a router 110 to enable the VPN tunnel. Once the VPN is established each camera 156-160 may be accessed by internet protocol (IP) access directly or through an IP conversion device for analog camera access. Images from the cameras are then received at the server 102 and provided to computing device 130. The server 102 can enable multiple devices to access the video images and not require multiple connections to be created to the building 150 infrastructure. The portal 114 may either capture individual images, such as JPEGs, from the cameras or convert a live video stream to individual images depending on bandwidth and processing constraints.

The communication with the server 102 may alternately be provided through a private network 122 infrastructure. The private network 122 may be a private wireless network (PWN), private shared wireless network (PSWN), Multiprotocol Label Switching (MPLS) or other wired private networking technologies to provide additional layers of access security. For example building 170 may require a connection through a private network 122 to enable VPN access. Similarly the emergency services request may also be provided through a dedicated or private network 122. The ERP portal enables emergency services to access information associated with a location through a 3^{rd} party provider ensure that the use of information associated with a location is tracked and logged to remove the opportunity for abuse or privacy violations. Any access to the information by emergency services results in notification of the property owner, or associated contacts, to ensure they know what information is being provided and when the information is being provided to government organizations. The ERP portal allows emergency services to quickly access up-to-date information on a location providing situational awareness before arriving on-scene and manage an evolving situations.

When secondary verification is required by security operations center 134 the requesting user identifies the type of access required. For example a police officer may be presented with a display to select the type of incident to justify the reason to access the site information.

URGENT REQUEST TO ACCESS DATA, a drop box is displayed as follows:

_Criminal Predicate

_Medical Emergency

_Public Safety

_Major Critical Incident

The users can access images from the camera via the server 102 and not directly requiring access from the cameras themselves. The server 102 enables multiple users to view the same camera, bypassing bandwidth limits from a property as well as limits simultaneous access to individual cameras. Real-time validation of access rules enables revoking permissions to “Eyes on Screen” users. Notification to property managers the first time a “First Responder Agency” initiates viewing of camera assets is provided to designated contacts. A list of active sites (Open VPNs) and active cameras is maintained by the server to reduce access times and bandwidth requires. The server may request individual images from the cameras rather than initiating live video streams depending on bandwidth capabilities available.

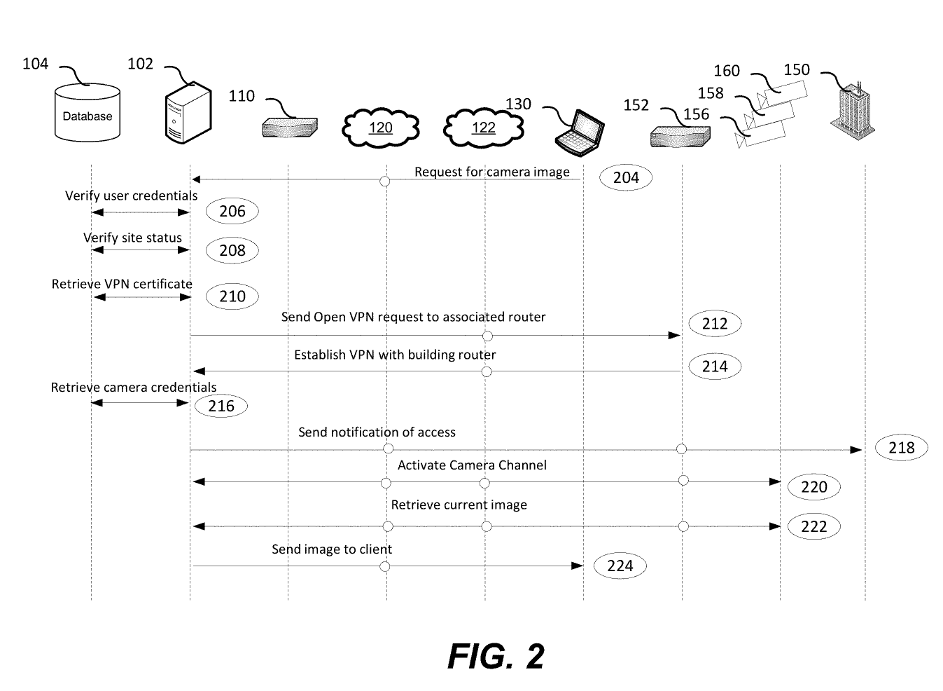

FIG. 2 shows a representation of message flow for video feed integrity. A request is received from a computing device 130 to access the camera 156-160 associated with a location or building 150 (204). The credentials of the user 130 are verified (206) and a secondary authorization may be initiated for example with a security operations center 134 (not shown). The status of the site 150 is verified to determine the information available and if any active VPNs are currently established (208) with associated router 152. If a VPN is not active, the VPN certificate is retrieved (210) and a VPN is initiated (212) with the router 152 at the associated site. The VPN may be configured to only accept VPN access from a particular IP address in addition to requiring the VPN access. After the VPN is established between the router 152 and the server 102 (214) the camera local area network IP addresses are retrieved (216) and logon credentials (login id, password) for each camera 156-160 or an associated network video server (NVS). Notification can then be provided to the building contacts when access is initiated or depending on which cameras are accessed (218). The camera channel is activated (220) and individual images are retrieved (222) by the server 102. The image is then sent to the client 130 (224). Multiple clients may access the image from the server 102 and do not require new connections to be established to router 152 or the associated cameras 156-160. When access is no longer required the VPN can be terminated. Notifications may also be generated on termination of the connection and log files stored at the server 102 to identify what was accessed and who access the information. The images are provided to the requesting access device 130 in an application executed on the device or within a web client executed on the mobile device. The device 130 may be provided still images from the video stream or a live video stream depending on network capacity. Multiple video streams can be aggregated and presented in a single location requiring only one access request from the device 130 wherein the server established connections to multiple cameras in addition to providing building related information or additional building controls such as alarm access.

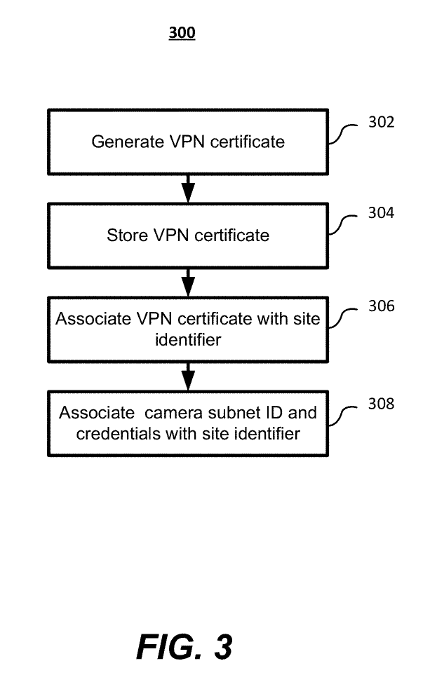

FIG. 3 shows a method 300 of commissioning video integrity. When a location is being entered into the ERP portal the associated router must be configured to enable a VPN with the server 102. A VPN certificate is generated for the router associated with a building (302) and stored on the server 102 (304). The VPN certificate is associated with a site identifier (306) and stored in the database. The cameras and the subnet of the intranet are associated with the credentials and site identifier in the database (308). The server 102 can then create VPNs with multiple routers at different building location as required. The VPN connections can be established on an as needed basis. The VPN allows access to the local intranet network to be able to retrieve camera video streams or images to be provided to external emergency services.

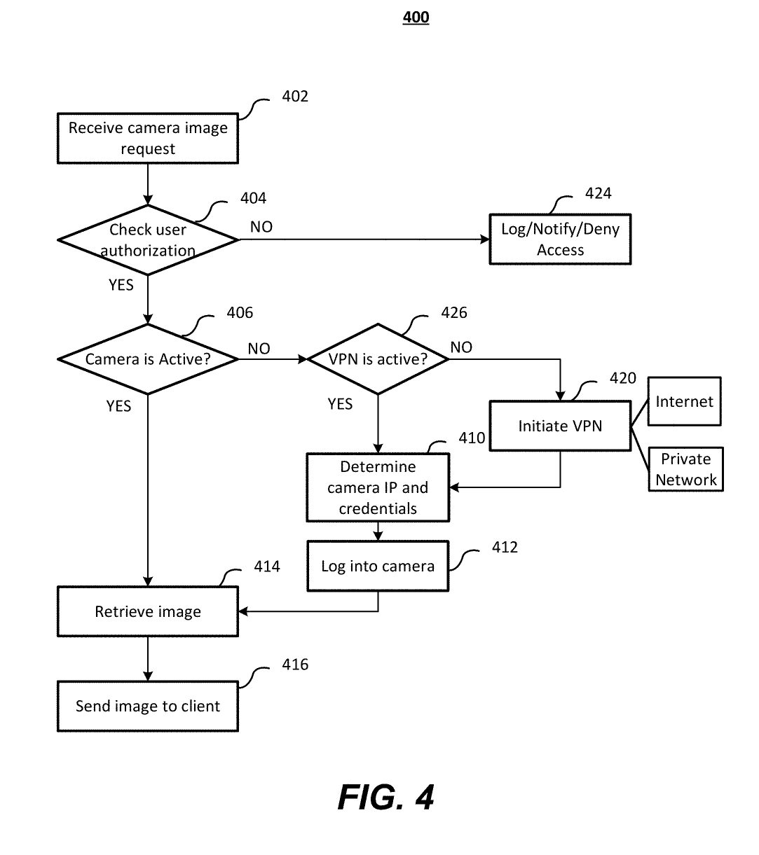

FIG. 4 shows a method 400 of operation of video feed integrity. The server 102 received a request from a computing device 130 associated with an emergency responder (402). The request identifies a site or building location selected through the ERP web portal or application and an identification code of the user requesting the information. The user credentials are verified to determine if they are authorized to access the information associated with the location. If the authorization fails (NO at 404) the access request is logged, a notification of the attempt is issued and access to the information is denied (424). The authorization may be performed just on verification of credentials or may be a two-step process requiring approval from an administrator of the location or security operations center which can be not located at the property location. If the authorization is verified (YES at 404), if a VPN session is already initiated the camera image (YES at 406) is retrieved either locally from the server 102 or by logging onto the requested camera or NVS using the camera IP subnet and logon credentials to retrieve and image or video stream (414). The image is then sent to the client (416) for display on the computing device. If the camera for the location is not active (NO at 406) it is determined if the VPN is active to the router associated with the location. If a VPN is active (YES at 426) the camera IP and credentials are determined from the database (410) and the server logs onto the camera (412) to retrieve images for local storage (414). If the VPN is not active (NO at 426) the certificate for the VPN are retrieved and a connection is initiated (420) to then access the requested camera (410). The location may also have additional access requirements defined such as the type of network connect required to access the router. For example communications may be by a private network and not through the Internet or public communication networks.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the system and method described herein may be provided by various combinations of software, firmware and/or hardware, other than the specific implementations described herein as illustrative examples.

In various embodiments devices, servers and nodes described herein are implemented using one or more components or modules to perform the steps corresponding to one or more methods, for example, has generation, transmitting, processing, and/or receiving steps. Thus, in some embodiments various features are implemented using components or modules. Such components or modules may be implemented using software, hardware or a combination of software and hardware. In some embodiments each component or module is implemented as an individual circuit with the device or system including a separate circuit for implementing the function corresponding to each described component or module. Many of the above described methods or method steps can be implemented using machine executable instructions, such as software, included in a machine readable medium such as a memory device, (e.g., as a ROM, for example a non-volatile memory such as flash memory, CD ROM, DVD ROM, Blu-ray™, a semiconductor ROM, USB, or a magnetic recording medium, for example a hard disk) to control a machine, e.g., general purpose computer with or without additional hardware, to implement all or portions of the above described methods, e.g., in one or more nodes or servers. Accordingly, among other things, various embodiments are directed to a machine-readable medium e.g., a non-transitory computer readable medium, including machine executable instructions for causing a machine, e.g., processor and/or associated hardware, to perform one or more or all of the steps of the above-described method(s).

It would be appreciated by one of ordinary skill in the art that the system and components shown in FIGS. 1-4 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A system for video integrity through an emergency response portal (ERP), the system comprising:
a router at a property locations coupled to an intranet the router having a virtual private network (VPN) certificate associated the emergency response portal; and
an ERP server coupled to a network for receiving an access request from a device associated with an emergency response service to information associated with a property location, the server configures the VPN with the router at the property location and accesses images from one or more cameras at the location to be provided to an emergency responder service through the ERP server;
wherein the server stores IP addresses associated with the one or more cameras and credentials to access the one or more cameras, and subsequent requests to access information for the property location is retrieved from the server, wherein images from the cameras are stored on the server rather than accessing the property location again.

2. The system of claim 1 wherein the router and server have corresponding VPN certificates.

3. The system of claims 2 wherein the server and router are connected via a private network.

4. The system of claim 3 wherein the one or more cameras are coupled to a network video server (NVS).

5. The system of claim 1 wherein a notification is sent to a contact associated with the property when the request is received to access one or more cameras at the location by the emergency responder service.

6. The system of claim 5 wherein credentials of the device or user of the emergency responder service are verified by the ERP server.

7. The system of claim 1 wherein the request to access the information is provided to a security operations centre external to the property location for confirmation before allowing access.

8. The system of claim 1 wherein the VPN is terminated between the portal and the router when the requesting device is not connected.

9. The system of claim 8 wherein the router is configured to only establish a VPN connection with a known static IP address of the server.

10. A method of video integrity at an emergency response portal, the method comprising:
a receiving a request from an emergency response service to access video associated with a property location at a server;
verifying credentials associated with the request at the server and generating a notification of an access request to a property owner associated with the location;
establishing a virtual private network (VPN) between the server and a router at the property location;
accessing one or more cameras at the location connected to an intranet at the location;
retrieving an image from the one or more cameras; and
providing the image to a device associated with the request from the emergency response service.

11. The method of claim 10 wherein establishing the VPN further comprises determining a VPN status between the server and a router at the location.

12. The method of claim 11 wherein the router and server have corresponding VPN certificates.

13. The method claim 12 wherein the server and router are connected via a private network separate from the network of an access device of the requesting emergency response service.

14. The method of claim 13 wherein the server stores IP addresses associated with the one or more cameras and credentials to access the one or more cameras.

15. The method claim 14 wherein subsequent requests to access information for the property location is retrieved from the server, wherein images from the cameras are stored on the server.

16. The method of claim 15 wherein credentials of the device or user of the emergency response service are verified.

17. The method of claim 16 wherein the request to access the information is provided to a security operations centre for confirmation before allowing access.

18. The method of claim 17 wherein a VPN connection is terminated between the server and the location when the requesting device is not connected.

19. The method of claim 18 wherein the images are extracted from a video feed from the one or more cameras.

20. A non-transitory computer readable memory containing instructions for video integrity at an emergency response portal, the instructions which when executed by a processor perform the method of:
a receiving a request from an emergency response service to access video associated with a property location at a server;
verifying credentials associated with the request at the server and generating a notification of an access request to a property owner associated with the location;
establishing a virtual private network (VPN) between the server and a router at the property location;
accessing one or more cameras at the location connected to an intranet at the location;
retrieving an image from the one or more cameras; and
providing the image to a device associated with the request from the emergency response service.
